(19) United States
(12) Patent Application Publication
(10) Pub. No.: US 2011/0273801 A1
(43) Pub. Date: Nov. 10, 2011

(54) PACKING METHOD FOR RECORDING TAPE CARTRIDGES AND PACKAGE OF RECORDING TAPE CARTRIDGES

(75) Inventor: Yosuke SUMIYA, Kanagawa (JP)

(73) Assignee: FUJIFILM CORPORATION, Tokyo (JP)

(21) Appl. No.: 13/095,921

(22) Filed: Apr. 28, 2011

(30) Foreign Application Priority Data
May 6, 2010 (JP) 2010-106621

(51) Int. Cl. G11B 23/113

(52) U.S. Cl. 360/132; G9B/23.078

(57) ABSTRACT

The invention is to provide a packing method for recording tape cartridges and a package of recording tape cartridges, which can prevent tape performance from being affected by humidity change when the recording tape cartridge is carried and can compact a storage case can be provided.

In a packing method for recording tape cartridges and a package of recording tape cartridges of the invention, a plurality of recording tape cartridges are stored in a storage case, each of the recording tape cartridges including a case having an upper case and a lower case and accommodating therein a reel on which a recording tape is wound, at least one recording tape cartridge, in which at least one of the upper case and the lower case is formed of a resin material having a humidity controlling effect, is stored in the storage case.

### CROSS-REFERENCE TO RELATED APPLICATION

This application claims priority under 35 USC 119 from Japanese Patent Application No. 2010-106621 filed May 6, 2010, the disclosure of which is incorporated by reference herein.

### BACKGROUND OF THE INVENTION

1. Field of the Invention

The present invention relates to a packing method for recording tape cartridges and a package of recording tape cartridges, the recording tape cartridge accommodating a reel on which a recording tape such as a magnetic tape is wound.

2. Related Art

In the related art, a recording tape cartridge in which a recording tape such as a magnetic tape used as a data recording/reproducing medium (data backup) of a computer is wound on a reel made of a synthetic resin and the single reel is accommodated is a case is known. The plural recording tape cartridges are stored (accommodated) in each storage case and are carried. In order to prevent tape performance from being affected by the humidity change when the recording tape cartridges are carried (hygroscopic expansion), a humidity controlling member is disposed in the storage case (for example, Japanese Patent Application Laid-Open (JP-A) No. 2009-78829).

However, in the configuration where the humidity controlling member is disposed in the storage case where the plural recording tape cartridges are stored, since a space for disposing the humidity controlling member in the storage case is needed, it is difficult to make smaller the size of the storage case.

### SUMMARY OF THE INVENTION

Accordingly, the present invention has been made in view of the above circumferences and the invention is to provide a packing method for recording tape cartridges and a package of recording tape cartridges that can prevent tape performance from being affected by the humidity change when the recording tape cartridge is carried and can make smaller the size of a storage case.

In order to achieve the above object, a first aspect of the present invention is a packing method for recording tape cartridges for storing a plurality of recording tape cartridges in a storage case, each of the recording tape cartridges including a case having an upper case and a lower case and accommodating therein a reel on which a recording tape is wound, the method including: storing at least one recording tape cartridge, in which at least one of the upper case and the lower case is formed of a resin material having a humidity controlling effect, in the storage case.

A sixth aspect of the invention is a package of recording tape cartridges including a plurality of recording tape cartridges stored in a storage case, each of the recording tape cartridges including a case having an upper case and a lower case and accommodating therein a reel on which a recording tape is wound, wherein at least one recording tape cartridge, in which at least one of the upper case and the lower case is formed of a resin material having a humidity controlling effect, is stored in the storage case.

According to the first aspect and the sixth aspect of the invention, the humidity of an inner portion of the storage case can be controlled by the recording tape cartridge where at least one of the upper case and the lower case is formed of the resin material having a humidity controlling effect. Therefore, tape performance can be prevented from being affected by the humidity change at the time of carrying. That is, corrosion caused by moisture absorption expansion of the recording tape and a read/write error in the recording/reproducing head of a drive device caused by the corrosion can be reduced. Therefore, since a humidity controlling member does not need to be additionally provided in the storage case, the storage case can be compacted (made smaller).

In addiction, a second aspect of the present invention is a packing method for recording tape cartridges, the method including: storing, in a storage case, at least one first recording tape cartridge including a case having an upper case and a lower case and accommodating therein a reel on which a recording tape is wound, at least one of the upper case and the lower case being formed of a resin material having a humidity controlling effect, and storing, in the storage case, a plurality of second recording tape cartridges each including a case having an upper case and a lower case and accommodating therein a reel on which a recording tape is wound, the upper case and the lower case being formed of a resin material not having the humidity controlling effect.

In addition, a seventh aspect of the invention is a package of recording tape cartridges comprising a storage case storing at least one first recording tape cartridge including a case having an upper case and a lower case and accommodating therein a reel on which a recording tape is wound, at least one of the upper case and the lower case being formed of a resin material having a humidity controlling effect, and a plurality of second recording tape cartridges each including a case having an upper case and a lower case and accommodating therein a reel on which a recording tape is wound, the upper case and the lower case being formed of a resin material not having the humidity controlling effect.

According to the second aspect and the seventh aspect of the invention, the humidity of an inner portion of the storage case can be controlled by the first recording tape cartridge where at least one of the upper case and the lower case is formed of the resin material having the humidity controlling effect. Therefore, tape performance can be prevented from being affected by the humidity change at the time of carrying. That is, corrosion caused by moisture absorption expansion of the recording tape and a read/write error in the recording/reproducing head of a drive device caused by the corrosion can be reduced. Therefore, since a humidity controlling member does not need to be additionally provided in the storage case, the storage case can be compacted.

In addition, in a third aspect of the invention according to the second aspect,

the upper case and the lower case of each of the first recording tape cartridge and the second recording tape cartridges have respective peripheral walls that abut each other, and the first recording tape cartridge and the second recording tape cartridges are stored in the storage case in a state where the peripheral walls are directed to the outside of the storage case.

In addition, in an eighth aspect of the invention according to the seventh aspect, the upper case and the lower case of each of the first recording tape cartridge and the second recording tape cartridges have respective peripheral walls that abut each other, and the first recording tape cartridge and the second recording tape cartridges are stored in the storage case in a state where the peripheral walls are directed to the outside of the storage case.

According to the third aspect and the eighth aspect of the invention, the humidity of an entire bundle of the recording tape cartridges that are stored in the storage case can be controlled.

In addition, in a fourth aspect of the invention according to the third aspect, when a number of the first recording tape cartridges is two or more in the storage case, one of the first recording tape cartridges is positioned at one of both end portions of the storage case, and another one of the first recording tape cartridges is positioned at the other of the both end portions of the storage case.

In addition, in a ninth aspect of the invention according to the eighth aspect, when a number of the first recording tape cartridges is two or more in the storage case, one of the first recording tape cartridges is positioned at one of both end portions of the storage case, and another one of the first recording tape cartridges is positioned at the other of the both end portions of the storage case.

According to the fourth aspect and the ninth aspect of the invention, in a case where the number of first recording tape cartridges is two or more, the humidity of an entire bundle of the recording tape cartridges that are stored in the storage case can be effectively controlled.

In addition, in a fifth aspect of the invention according to the third aspect,

when a number of the first recording tape cartridge is less than a number of the second recording tape cartridges in the storage case, at least one first recording tape cartridge is sandwiched by two of the second recording tape cartridges.

In addition, in a tenth aspect of the invention according to the eighth aspect, when a number of the first recording tape cartridge is less than a number of the second recording tape cartridges in the storage case, at least one first recording tape cartridge is sandwiched by two of the second recording tape cartridges.

According to the fifth aspect and the tenth aspect of the invention, in a case where the number of first recording tape cartridges is less than the number of second recording tape cartridges, the humidity of an entire bundle of the recording tape cartridges that are stored in the storage case can be effectively controlled.

As such, according to the invention, a packing method and a package of recording tape cartridges that can prevent tape performance from being affected by the humidity change when the recording tape cartridges are carried and can compact a storage case can be provided.

### BRIEF DESCRIPTION OF THE DRAWINGS

Exemplary embodiments of the present invention will be described in detail with reference to the following figures, wherein:

FIG. 1 is a schematic perspective view of a recording tape cartridge;

FIG. 2 is a schematic exploded perspective view of the recording tape cartridge when viewed from the upper side;

FIG. 3 is a schematic exploded perspective view of the recording tape cartridge when viewed from the lower side;

FIG. 4 is a schematic perspective view showing an aspect where the recording tape cartridge is stored in both end portions of a storage case;

FIG. 5 is a schematic perspective view of a package of the recording tape cartridge; and

FIG. 6 is a schematic perspective view showing an aspect where the recording tape cartridge is stored in a center portion of the storage case.

### DETAILED DESCRIPTION OF THE INVENTION

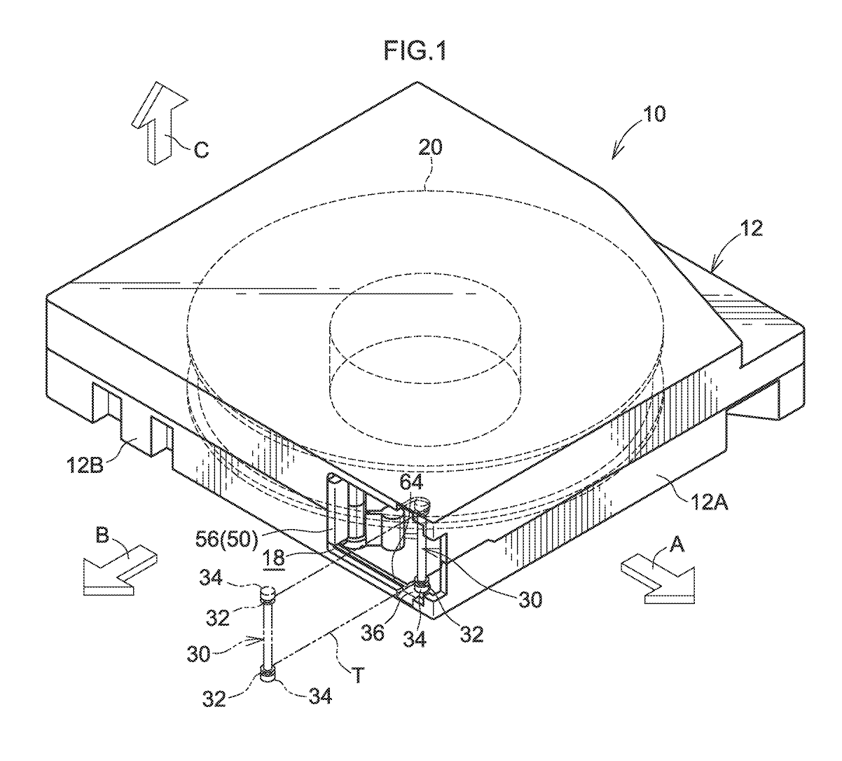

Hereinafter, an exemplary embodiment of the present invention will be described with reference to the accompanying drawings. In FIG. 1, in order to simplify the description, a loading direction of a recording tape cartridge 10 with respect to a drive device is shown by an arrow A and is set as a front direction (front side) of the recording tape cartridge 10. A direction that is shown by an arrow B orthogonal to the direction shown by the arrow A is set as a right direction (right side). A direction that is orthogonal to the direction shown by the arrow A and the direction shown by the arrow B is shown by an arrow C and is set as an upper direction (upper side) of the recording tape cartridge 10.

First, the recording tape cartridge 10 (a second recording tape cartridge) that is formed of a resin material that does not have a humidity controlling effect will be described. In this exemplary embodiment, the resin material that does not have the humidity controlling effect is a resin material (general purpose engineer plastic such as polycarbonate) in which heat-resistant layered porous silica is not mixed, which will be described below.

As shown in FIGS. 1 to 3, the recording tape cartridge 10 has a case 12 that has an approximately rectangular box shape. The case 12 is configured by bonding an upper case 14 and a lower case 16 which are made of a resin material such as polycarbonate (PC) using such as ultrasonic welding or screw fastening, in a state where a peripheral wall 14B erected on a peripheral edge of a ceiling plate 14A and a peripheral wall 16B erected on a peripheral edge of a bottom plate 16A contact (abut) each other.

That is, in the upper case 14 and the lower case 16, screw bosses 15 are formed in the vicinity of respective corners, screws (not shown in the drawings) are screwed to the screw bosses 15 from the bottom surface side of the lower case 16, so the case 12 is assembled. Inside the case 12, a single reel 20 which is formed of a resin material such as polycarbonate (PC) and on which the recording tape T is wound is rotatably accommodated.

The reel 20 has the configuration where a reel hub 22 constituting a shaft center portion and having a cylindrical shape having a bottom and a lower flange 26 provided on a lower end portion of the reel hub are integrally formed, and an upper flange 24 is welded on an upper end portion of the reel hub 22 by the ultrasonic welding. The recording tape T such as a magnetic tape that functions as an information recording/reproducing medium is wound on an outer circumferential surface of the reel hub 22, and both end portions of the wound recording tape T in a width direction are held by the upper flange 24 and the lower flange 26.

On a bottom surface (an external surface) of a bottom wall (bottom portion) 28 of the reel hub 22, a reel gear 44 is annularly formed. In approximately a center portion of the lower case 16, a gear opening portion 40 for exposing the reel gear 44 to the outside is formed. The reel gear 44 that is exposed from the gear opening portion 40 is engaged with a driving gear (not shown in the drawings) that is formed in a rotation shaft (not shown in the drawings) of the drive device and is rotation driven. As a result, in the case 12, the reel 20 can rotate relatively with respect to the case 12.

At the inner side in a radial direction of the reel gear 44 on the bottom surface of the bottom wall 28, a reel plate 46 that is an annular metal plate formed of a magnetic material is coaxially and integrally fixed by insert forming, and is absorbed and held by the magnetic force of an annular magnet (not shown in the drawings) provided on the rotation shaft of the drive device. The reel 20 is held such that rattling is prevented by play regulating walls 42 partially protruded at the inner surfaces of the upper case 14 and the lower case 16 and each serving as an inner wall on a circular locus coaxial with the gear opening portion 40.

In a right wall 12B of the case 12, an opening 18 for drawing the recording tape T wound on the reel 20 is formed. On a free end portion of the recording tape T that is drawn from the opening 18, a leader pin 30 serving as a leader member, that is operated to be drawn while being caught (engaged) by a drawing member (not shown in the drawings) of the drive device, is fixed. At both end portions of the leader pin 30 that protrude further than end portions of the recording tape T in a width direction, annular grooves 32 are formed, and the annular grooves 32 are caught to hooks or the like of the drawing member.

On the inner side of the opening 18 of the case 12, that is, an inner surface of the ceiling plate 14A of the upper case 14 and an inner surface of the bottom plate 16A of the lower case 16, a pair of upper and lower pin holding portions 36 that position and hold the leader pin 30 in the case 12 are provided. The pin holding portions 36 have an approximately semicircular shape where the drawing side of the recording tape T is opened, and both end portions 34 of the leader pin 30 in an upright state can enter in or go out from, from the opening side, the inner side of the pin holding portions 36.

In the vicinity of the pin holding portions 36, a plate spring 38 is fixedly disposed, and front end portions of bifurcated shape of the plate spring 38 are engaged with upper and lower end portions 34 of the leader pin 30 respectively so as to hold the leader pin 30 in the pin holding portions 36. When the leader pin 30 is entered in or gone out from the pin holding portion 36, the front end portions of the plate spring 38 are appropriately elastically deformed so as to allow movement of the leader pin 30.

The opening 18 is opened and closed by a door 50. The door 50 is formed in an approximately rectangular plate shape with a size enable to close the opening 18. Grooves 64 where upper and lower end portions of the door 50 are slidably fit are formed in the ceiling plate 14A and the bottom plate 16A at the inner side of the opening 18 such that the door 50 can move along the right wall 12B of the case 12.

A shaft 52 protrudes from the center of a rear end portion of the door 50 and a coil spring 58 is fitted to the shaft 52. On a rear end portion of the shaft 52, an expand-portion 54 that prevents falling of the coil spring 58 is formed. In the lower case 16, a support stand 60 that has a catching portion 62 that catches a rear end portion of the coil spring 58 fitted to the shaft 52 protrudes.

Therefore, the door 50 is configured such that, the shaft 52 is slidably supported on the support stand 60, and the rear end portion of the coil spring 58 is caught to the catching portion 62, so the door 50 is always biased in a closing direction of the opening 18 by the biasing force of the coil spring 58. It is preferable that a support stand 66 that supports the shaft 52 is further provided in protrude-manner at the rear side of the support stand 60.

In a front end portion of the door 50, a convex portion 56 for an opening/closing operation protrudes to the outside. The convex portion 56 is engaged with an opening/closing member (not shown in the drawings) of the drive device side according to loading of the recording tape cartridge 10 to the drive device. Thereby, the door 50 is opened against the biasing force of the coil spring 58.

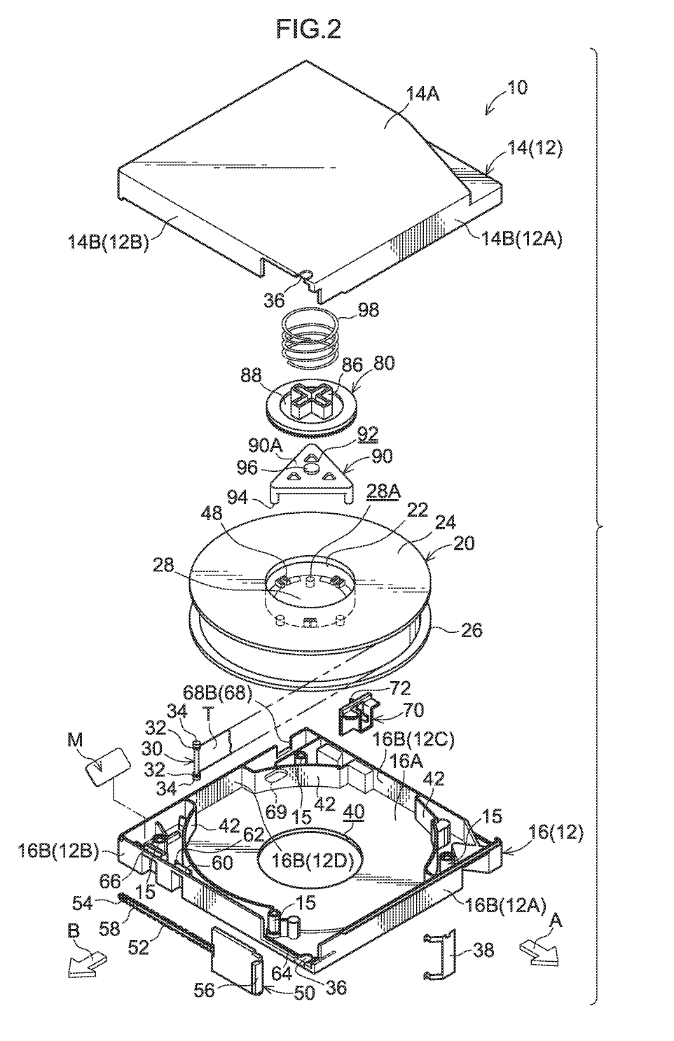

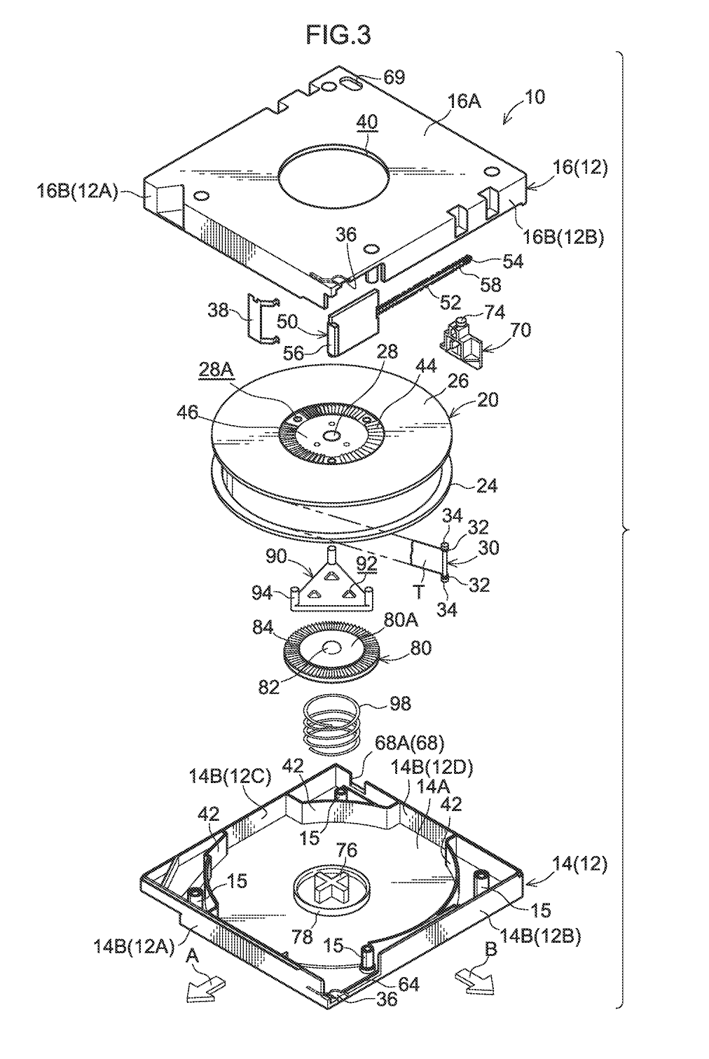

As shown in FIGS. 2 and 3, in a left rear portion of the case 12, a write-protect 70 where permission or non-permission of recording with respect to the recording tape T is set is slidably provided in a left and right direction. In a rear wall 12D of the case 12, an opening 68 from which an operation protrusion 72 is protruded such that the write-protect 70 is manually operated is formed. The opening 68 is formed by a notch portion 68A formed in the peripheral wall 14B of the upper case 14 and a notch portion 68B formed in the peripheral wall 16B of the lower case 16, when the upper case 14 and the lower case 16 are bonded to each other.

In the lower case 16, an elongated hole 69 where the protrusion portion 74 of the write-protect 70 is exposed is formed in long-manner in a left and right direction. When the recording tape cartridge 10 is loaded on the drive device, the position of the write-protect 70 is detected at the drive device side, and permission or non-permission of recording to the recording tape T is automatically judged. The protrusion portion 74 does not protrude from the bottom surface of the lower case 16. As shown in FIG. 2, in a right rear portion of the case 12, a memory board M where various information such as the recording capacity and the recording format is stored is disposed at a predetermined inclined angle (for example, 45 degrees).

As shown in FIGS. 2 and 3, on the peripheral edge of the top surface of the bottom wall 28 of the reel hub 22, plural engagement gears 48 are provided in standing manner at a predetermined interval therebetween (at an equivalent interval) (for example, three engagement gears are provided at an interval of 120 degrees). At the predetermined positions corresponding to positions on the reel gear 44, between the engagement gears 48, plural through-holes 28A are formed (in this case, three through-holes are formed at an interval of 120 degrees). A brake member 80 that is formed of a resin material and has an approximately circular plate shape is provided in interested manner in the reel hub 22.

On the peripheral edge of a bottom surface 80A of the brake member 80, a brake gear 84 that can be engaged with the engagement gears 48 is annularly formed. On a top surface of the brake member 80, an engagement protrusion 86, into which a rotation regulating rib 76 protruding toward a lower direction from an inner surface of the ceiling plate 14A of the upper case 14 and having an approximately cross shape in plan view is inserted and which has an approximately cross shape in plan view, is provided in standing manner so as to be slightly higher than the height of the rotation regulating member 76. Thereby, the brake member 80 cannot rotate with respect to the case 12 (the upper case 14) and can move in an upper and lower direction in the reel hub 22.

Between the upper case 14 and the brake member 80, a compression coil spring 98 is disposed. That is, the compression coil spring 98 is disposed in a state where one end portion thereof abuts the inner side of the annular protrusion 78 which is provided to protrude at the outside of the rotation regulating rib 76 of the upper case 14 (between the rotation regulating rib 76 and the annular protrusion 78) and the other end portion thereof abuts in the annular groove 88 provided on the top surface of the brake member 80. By the biasing force of the compression coil spring 98, the brake member 80 is always biased to the lower side.

Therefore, when the recording tape cartridge 10 is not used (the recording tape cartridge 10 is not loaded on the drive device), the brake gear 84 is always engaged with the engagement gear 48 and relative rotation of the reel 20 with respect to the case 12 is prohibited so as to be in a state of a rotation locking The reel 20 is pushed to the side of the lower case 16 by the biasing force such that the reel gear 44 is exposed from the gear opening portion 40.

In the lower side of the brake member 80 (between the bottom wall 28 and the brake member 80) inside the reel hub 22, a releasing member 90 that is formed of a resin material and has an equilateral triangular shape in plan view is provided in inserted manner. Plural (three) through-holes 92 that are formed in a predetermined shape are provided at the appropriate positions in the releasing member 90, so the weight of the releasing member 90 is decreased. In each apex portion on the bottom surface of the releasing member 90, a leg portion 94, that is inserted into the insertion hole 28A and protrudes with the predetermined height from the bottom surface of the bottom wall 28 on the reel gear 44, is provided in protrude manner.

A support convex portion 96 having a planar shape is formed at the center of the top surface 90A of the releasing member 90. A releasing protrusion 82 that is provided in protrude manner at the center of the bottom surface 80A of the brake member 80 and has an approximately semispherical shape abuts (refer to FIGS. 2 and 3) to the support convex portion 96. Thereby, a contact area of the brake member 80 and the releasing member 90 is reduced and sliding resistance at the time of use (at the time of rotation of the reel 20) is reduced. As a material for the brake member 80, polyacetal (POM) is used. As a material for the releasing member 90, polybutylene terephthalate (PBT) is used.

Next, an operation of the recording tape cartridge 10 that has the above configuration will be described. When the recording tape cartridge 10 is not used (when the recording tape cartridge 10 is stored or carried), the opening 18 of the recording tape cartridge 10 is closed by the door 50. By the biasing force of the compression coil spring 98, the brake member 80 is positioned at the rotation lock position, and engages the brake gear 84 with the engagement gear 48. Thereby, the rotation of the reel 20 with respect to the case 12 is prohibited.

When the recording tape T is used, the recording tape cartridge 10 is loaded in the drive device along a direction shown by an arrow A, with the front wall 12A being top. In this case, first, the opening/closing member that is provided on the drive device side is engaged with the convex portion 56 of the door 50. In this state, if the recording tape cartridge 10 further moves in the direction shown by the arrow A, the opening/closing member relatively moves the convex portion 56 to the rear side against the biasing force of the coil spring 58. The door 50 where the convex portion 56 protrudes is slid to the rear side in the groove portion 64 along the right wall 12B and opens the opening 18.

In this way, if the recording tape cartridge 10 is loaded in the drive device in the predetermined depth and the opening 18 is completely opened, the recording tape cartridge 10 descends by the predetermined height and a positioning member (not shown in the drawings) of the drive device is inserted into a positioning hole (not shown in the drawings) that is formed in the lower case 16. Thereby, the recording tape cartridge 10 is accurately positioned at the predetermined position in the drive device, and further sliding of the door 50 (movement to the rear side) is regulated.

By the descending action of the recording tape cartridge 10, the rotation shaft relatively enters from the gear opening portion 40 and engages the driving gear with the reel gear 44. Then, the leg portions 94 that protrude on the reel gear 44 are raised against the biasing force of the compression coil spring 98 according to the engagement action of the driving gear and the reel gear 44, and the brake member 80 is raised to upper side via the releasing member 90 so the brake gear 84 and the engagement gear 48 are disengaged.

In a state where the driving gear and the reel gear 44 are completely engaged with each other, the reel plate 46 is absorbed and held by the magnetic force of the annular magnet provided on the inner side of the driving gear. So the relative rotation of the reel 20 with respect to the case 12 is enabled in the case 12, while engagement of the reel gear 44 with respect to the driving gear is maintained. That is, it is a lock releasing state.

Meanwhile, the drawing member that is provided on the drive device side is entered into the case 12 from the opened opening 18, and holds and draws the leader pin 30 that is positioned and held in the pin holding portion 36. At this time, since the recording tape cartridge 10 is accurately positioned in the drive device, the drawing member surely catches the hook to the annular groove 32 of the leader pin 30. Since the rotation locking state of the reel 20 is released, the reel 20 can rotate according to the drawing action of the leader pin 30.

In this way, the leader pin 30 that is drawn from the opening 18 is accommodated in a winding reel (not shown in the drawings). By synchronously driving the rotation of the winding reel and the reel 20, the recording tape T is drawn sequentially from the case 12 while being wound on the winding reel. On the recording tape T, information is recorded or reproduced by a recording/reproducing head (not shown in the drawings) that is disposed along a predetermined tape path.

When the recording tape cartridge 10 in which recording or reproduction of the information is completed is discharged from the drive device, first, the rotation shaft reversely rotates and the recording tape T is rewound on the reel 20. When the recording tape T is completely rewound on the reel 20 and the leader pin 30 is held in the pin holding portion 36, the recording tape cartridge 10 ascends by the predetermined height, the positioning member is extracted from the positioning hole, the rotation shaft is extracted from the gear opening portion 40, and engagement of the driving gear to the reel gear 44 is released.

Then, the brake member 80 and the releasing member 90 are pushed and pressed in a lower direction by the biasing force of the compression coil spring 98, the each leg portion 94 that is inserted into the through-hole 28A protrudes from the bottom surface of the bottom wall 28 on the upper side of the reel gear 44 by the predetermined height, and the brake gear 84 is engaged with the engagement gear 48. Thereby, the relative rotation of the reel 20 in the case 12 is prohibited, that is, it is the rotation locking state. Then, the recording tape cartridge 10 moves in a direction opposite to the direction shown by the arrow A by an ejection mechanism (not shown in the drawings).

As a result, according to the movement, the door 50 is slid in a closing direction of the opening 18 by the biasing force of the coil spring 58 and completely closes the opening 18 (returns to an initial state). In this way, the relative rotation of the reel 20 with respect to the case 12 is locked and the recording tape cartridge 10 where the opening 18 is closed is completely discharged from the drive device.

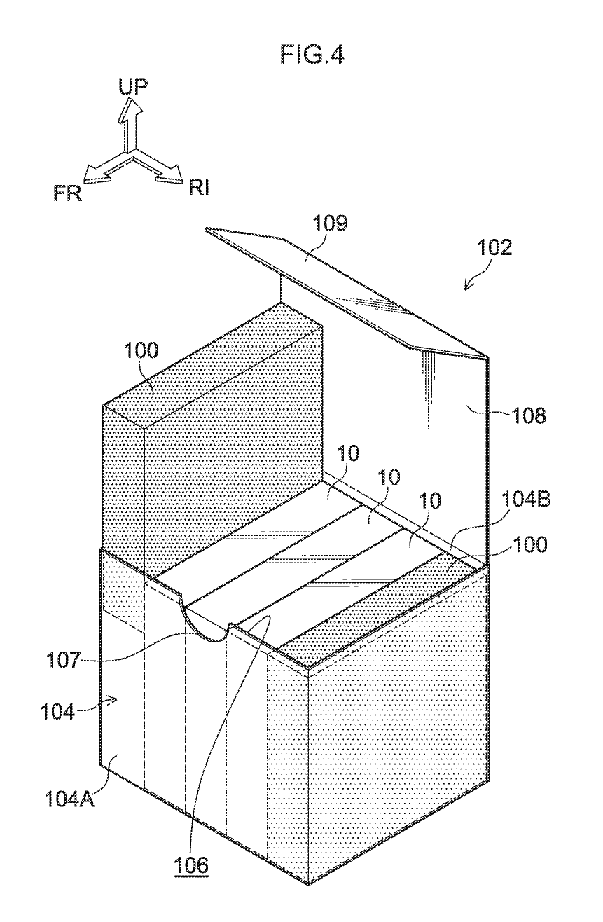

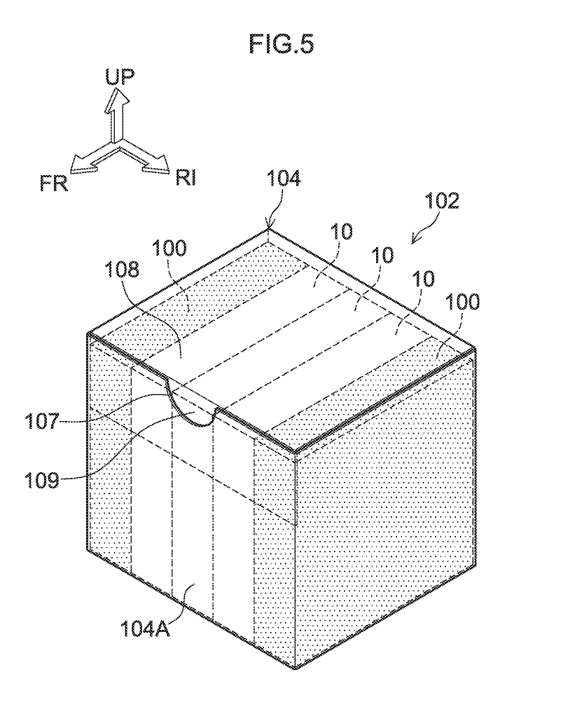

Next, a packing method and a package 102 of the recording tape cartridges 10 having the above configuration at the time of carrying will be described. In FIGS. 4 to 6, a direction shown by an arrow FR is set as a front direction of the package 102, a direction shown by an arrow RI is set as a right direction of the package 102, and a direction shown by an arrow UP is set as an upper direction of the package 102. As shown in FIGS. 4 and 5, when the recording tape cartridges are carried, the plural (five in the drawings) recording tape cartridges 10 (including a recording tape cartridge(s) 100 to be described below) are stored (accommodated) in a rectangular box-like storage case 104 formed of a cardboard (corrugated fiberboard) for example.

That is, each recording tape cartridge 10 is accommodated in the storage case 104 in a so-called longitudinal placed state with the peripheral walls 14B and 16B (the front wall 12A, the right wall 12B, the left wall 12C, and the rear wall 12D) being directed toward the outside of the storage case 104 (the upper and lower directions and the front and rear directions) (state where the ceiling plate 14A and the bottom plate 16A are piled (the ceiling plate 14A of one recording tape cartridge and the bottom plate 16A of another recording tape cartridge contact) in the left and right direction). The storage case 104 is formed to have a size where the plural (for example, 5) recording tape cartridges 10 (including the recording tape cartridge(s) 100 to be described below) are stored with substantially no gaps (spaces).

After the plural (for example, 5) recording tape cartridges 10 (including the recording tape cartridge 100 to be described below) are accommodated in the storage case 104 with substantially no gaps (in a state where there is substantially no gap in the front and rear directions, the upper and lower directions, and the left and right directions in the storage case 104 (between the case 104 and the recording tape cartridges)), the opening 106 at the upper side of the storage case 104 is sealed by a cover body 108 that is provided in connected arrangement to the rear wall 104B of the storage case 104, so the package 102 shown in FIG. 5 is configured.

A notch portion 107 having a semicircular arc shape is formed in a center portion of an edge of the opening 106 at the side of the front wall 104A of the storage case 104. The notch portion 107 is formed for that a finger or a hand can be placed on an insertion flap 109 provided in connected arrangement to a front end portion of the cover body 108 such that the storage case 104 (the package 102) is easily opened even though the plural recording tape cartridges 10 (including the recording tape cartridge 100 to be described below) are accommodated in the storage case 104 with substantially no gaps (refer to FIGS. 4 to 6).

In the package 102 (the storage case 104), at least one the recording tape cartridge 100 (first recording tape cartridge) where at least one of the upper case 14 and the lower case 16 is formed of a resin material (to be described below) having a humidity controlling effect is mixed (entered) and accommodated. Therefore, in the storage case 104 (the package 102), the humidity is controlled by the recording tape cartridge 100 (the case 12).

Here, the resin material that has the humidity controlling effect will be described. The resin material is obtained by mixing a heat-resistant layer silica porous material having a honeycomb-like porous structure synthesized by acting a layer silicate surfactant, with a synthesis resin, such as polyvinyl chloride (PVC), polyethylene (PE), polypropylene (PP), polystyrene (PS), polyurethane (PU), polyamide (PA), polycarbonate (PC), and acrylonitrile-butadiene-styrene (ABS).

The heat-resistant layered silica porous material is obtained by exchanging alkali metal ions existing between layers in crystalline layered silicate having the water content of 10 wt % (percentage by weight) or more, with positive ions of an organic matter, introducing the positive ions of the organic matter between layers, sintering the crystalline layered silicate obtained by removing the alkali metal ions liberated by the ion exchange under an oxidizing atmosphere of 600° C. to 1200° C., and burning the positive ions of the organic matter.

The crystalline layered silicate can be synthesized from amorphous silicate. Examples of the amorphous silicate include powdery sodium silicate on the market. Specific examples of the crystalline layered silicate include kanemite (NaHSi₂O₅.3H₂O), sodium silicate (Na₂Si₂O₃), makatite (Na₂Si₄O₉.5H₂O), ilerite (Na₂Si₈O₁₇.XH₂O), magadiite (Na₂Si₁₄O₂₉.XH₂O), and kenyaite (Na₂Si₂₀O₄₁.XH₂O).

Next, an operation of the package 102 where the recording tape cartridge(s) 100 is mixed (entered) will be described. As described above, the package 102 is configured by accommodating at least one recording tape cartridge 100 where the case 12 (at least one of the upper case 14 and the lower case 16) is formed of the resin material having the humidity controlling effect and the plural recording tape cartridges 10 where the case 12 is not formed of the resin material having the humidity controlling effect in the storage case 104.

As described above, the recording tape cartridges 10 and 100 are accommodated in the storage case 104 in a longitudinal placed state with the peripheral walls 14B and 16B (the front wall 12A, the right wall 12B, the left wall 12C, and the rear wall 12D) being directed toward the outside (the upper and lower directions and the front and rear directions) (in a state where the ceiling plate 14A and the bottom plate 16A are piled in the left and right direction). Therefore, the humidity of the inner portion of the storage case 104 can be controlled by at least the front wall 12A, the right wall 12B, the left wall 12C, and the rear wall 12D of the case 12 formed of the resin material having the humidity controlling effect.

That is, in the recording tape cartridge 100 that is accommodated in the longitudinal placed state, since the front wall 12A, the right wall 12B, the left wall 12C, and the rear wall 12D can always be exposed to external air (face the inner wall surfaces of the storage case 104), the humidity can be controlled inside the storage case 104 (an entire bundle of the recording tape cartridges 10 and 100).

Therefore, in the package 102, the tape performance can be prevented from being affected by the humidity change at the time of carrying, and corrosion caused by moisture absorption expansion of the recording tape T and a read/write error in the recording/reproducing head of the drive device caused by the corrosion can be reduced. For this reason, the package 102 is particularly effective in the recording tape T formed to be elongated and thin for the high capacity.

In the package 102, since a humidity controlling member does not need to be additionally provided in the storage case 104, the storage case 104 can be made smaller. That is, since it is enough that the storage case 104 is formed to have a size to accommodate the plural (for example, five) recording tape cartridges 10 and 100 with substantially no gap, the size of the storage case 104 can be minimized. Thereby, since a material cost of the storage case 104 can be decreased, a manufacturing cost thereof can be decreased.

In a case where the number of the recording tape cartridges 100 where the case 12 (at least one of the upper case 14 and the lower case 16) is formed of the reins material having the humidity controlling effect is two or more, as shown in FIGS. 4 and 5, each recording tape cartridge 100 is preferably accommodated (positioned) in both end portions (positions including the both end portions) of the storage case 104.

According to this configuration, since the upper case 14 (including the ceiling plate 14A and the peripheral wall 14B) of one recording tape cartridge 100 formed of the resin material having the humidity controlling effect and the lower case 16 (including the bottom plate 16A and the peripheral wall 16B) of the other recording tape cartridge 100 formed of the resin material having the humidity controlling effect are exposed to the external air via the storage case 104 (face the inner wall surfaces of the storage case 104), the humidity can be effectively controlled in the storage case 104 (the entire bundle of the recording tape cartridges 10 and 100).

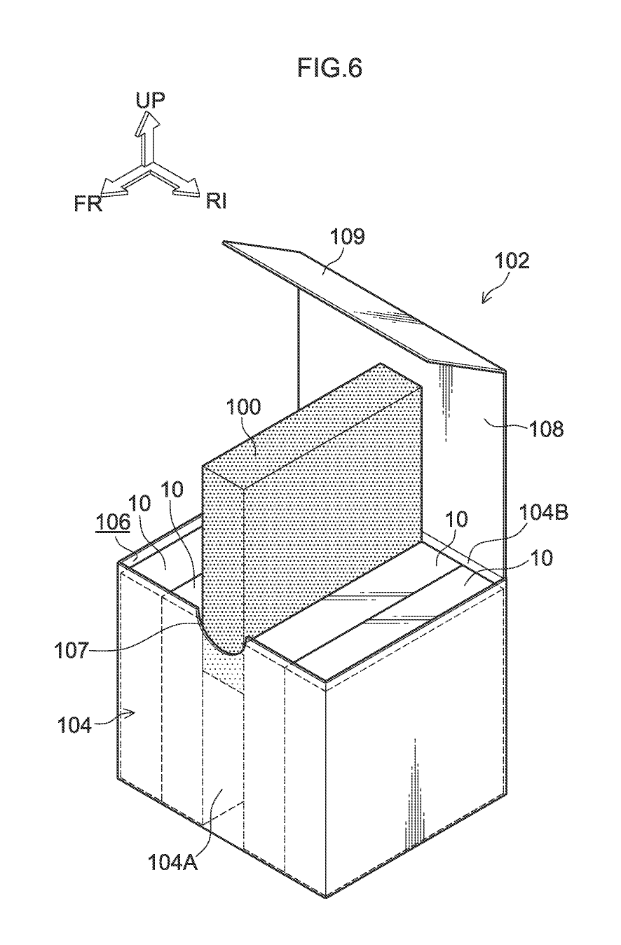

In a case where the number of the recording tape cartridges 100 where the case 12 is formed of the reins material having the humidity controlling effect is less than the number of the recording tape cartridges 10 where the case 12 is not formed of the reins material having the humidity controlling effect, for example, in a case where the number of the recording tape cartridges 100 is one, as shown in FIG. 6, the recording tape cartridge 100 is preferably accommodated so as to be sandwiched by the recording tape cartridges 10. In this case, the recording tape cartridge 100 is preferably accommodated in the center portion of the storage case 104 in the left and right direction.

According to this configuration, since the front wall 12A, the right wall 12B, the left wall 12C, and the rear wall 12D (peripheral walls 14B and 16B) of the case 12 of the recording tape cartridge 100 formed of the resin material having the humidity controlling effect are exposed to the external air (face the inner wall surfaces of the storage case 104) at the center portion of the storage case 104 in the left and right direction, the humidity can be substantially equally (effectively) controlled in the storage case 104 (the entire bundle of the recording tape cartridges 10 and 100).

The formation material of the storage case 104 is not limited to the cardboard described above, and the storage case 104 may be formed of a transparent and thin plastic material. The door 50 may be formed of the resin material having the humidity controlling effect. However, it is preferable that the reel 20 is not formed of the resin material having the humidity controlling effect, because high dimension precision is required in the reel. By two-color molding, at least part of the peripheral walls 14B and 16B may be formed of the resin material having the humidity controlling effect.

The packing method and the package 102 of the recording tape cartridges 10 and 100 according to this exemplary embodiment are described. However, the packing method and the package 102 according to this exemplary embodiment are not limited to the examples shown in the drawings, and various design changes can be appropriately made without departing from the scope of the invention. For example, in the storage case 104, only the recording tape cartridges 100 where the case 12 is formed of the resin material having the humidity controlling effect may be accommodated.

The recording tape T that is wound on the reel 20 may be any long tape-like information recording/reproducing medium where information can be recorded and recorded information can be reproduced, and the recording tape cartridge 10 that accommodates the reel 20 may be applied to the recording tape T of any recording/reproducing system.

What is claimed is:

1. A packing method for recording tape cartridges for storing a plurality of recording tape cartridges in a storage case, each of the recording tape cartridges including a case having an upper case and a lower case and accommodating therein a reel on which a recording tape is wound, the method comprising:
storing at least one recording tape cartridge, in which at least one of the upper case and the lower case is formed of a resin material having a humidity controlling effect, in the storage case.

2. A packing method for recording tape cartridges, the method comprising:
storing, in a storage case, at least one first recording tape cartridge including a case having an upper case and a lower case and accommodating therein a reel on which a recording tape is wound, at least one of the upper case and the lower case being formed of a resin material having a humidity controlling effect, and
storing, in the storage case, a plurality of second recording tape cartridges each including a case having an upper case and a lower case and accommodating therein a reel on which a recording tape is wound, the upper case and the lower case being formed of a resin material not having the humidity controlling effect.

3. The packing method for recording tape cartridges of claim 2, wherein
the upper case and the lower case of each of the first recording tape cartridge and the second recording tape cartridges have respective peripheral walls that abut each other, and
the first recording tape cartridge and the second recording tape cartridges are stored in the storage case in a state where the peripheral walls are directed to the outside of the storage case.

4. The packing method for recording tape cartridges of claim 3, wherein,
when a number of the first recording tape cartridges is two or more in the storage case, one of the first recording tape cartridges is positioned at one of both end portions of the storage case, and another one of the first recording tape cartridges is positioned at the other of the both end portions of the storage case.

5. The packing method for recording tape cartridges of claim 3, wherein,
when a number of the first recording tape cartridge is less than a number of the second recording tape cartridges in the storage case, at least one first recording tape cartridge is sandwiched by two of the second recording tape cartridges.

6. A package of recording tape cartridges comprising a plurality of recording tape cartridges stored in a storage case, each of the recording tape cartridges including a case having an upper case and a lower case and accommodating therein a reel on which a recording tape is wound,
wherein at least one recording tape cartridge, in which at least one of the upper case and the lower case is formed of a resin material having a humidity controlling effect, is stored in the storage case.

7. A package of recording tape cartridges comprising a storage case storing:
at least one first recording tape cartridge including a case having an upper case and a lower case and accommodating therein a reel on which a recording tape is wound, at least one of the upper case and the lower case being formed of a resin material having a humidity controlling effect, and
a plurality of second recording tape cartridges each including a case having an upper case and a lower case and accommodating therein a reel on which a recording tape is wound, the upper case and the lower case being formed of a resin material not having the humidity controlling effect.

8. The package of recording tape cartridges of claim 7, wherein
the upper case and the lower case of each of the first recording tape cartridge and the second recording tape cartridges have respective peripheral walls that abut each other, and
the first recording tape cartridge and the second recording tape cartridges are stored in the storage case in a state where the peripheral walls are directed to the outside of the storage case.

9. The package of recording tape cartridges of claim 8, wherein,
when a number of the first recording tape cartridges is two or more in the storage case, one of the first recording tape cartridges is positioned at one of both end portions of the storage case, and another one of the first recording tape cartridges is positioned at the other of the both end portions of the storage case.

10. The package of recording tape cartridges of claim 8, wherein,
when a number of the first recording tape cartridge is less than a number of the second recording tape cartridges in the storage case, at least one first recording tape cartridge is sandwiched by two of the second recording tape cartridges.
